(19) United States
(12) Patent Application Publication
(10) Pub. No.: US 2006/0126951 A1
(43) Pub. Date: Jun. 15, 2006

(54) Method of coding and decoding still picture

(75) Inventors: Jin Soo Lee, Seoul (KR); Min Sub Kim, Seoul (KR); Byoung Su Kang, Seongnam-si (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/304,391

(22) Filed: Dec. 14, 2005

(30) Foreign Application Priority Data
Dec. 14, 2004 (KR) 10-2004-0105724

(51) Int. Cl. G06K 9/36

(52) U.S. Cl. 382/232

(57) ABSTRACT

A method of coding/decoding a still picture is provided. The coding method includes transforming color components of image data based on a first color space into components on a first color space using an integer-integer color transform, and constructing frames for the transformed components on the second color space and coding image data of the frames. In the decoding method, the coded image data are transformed form the second color space to the fist color space and a dictionary-based decoding operation is performed.

This application claims the benefit of the Korean Patent Application No. 10-2004-0105724, filed on Dec. 14, 2004, which is hereby incorporated by reference as if fully set forth herein.

### BACKGROUND OF THE INVENTION

1. Field of the Invention

The present invention relates to a method of coding and decoding a still picture.

2. Description of the Related Art

Various kinds of mobile terminals have been provided. Although the mobile terminals get miniaturized, the resolution of screen is increasing and the number of colors expressible per pixel is increasing. Also, high-quality displays tend to be mounted.

In the mobile terminals, user interface (UI) is developed toward three-dimensional image and animation UI, as well as simple image. Accordingly, there is an increasing demand for memory space for recording an image stored in the mobile terminal and displaying it for the user interface. Developments of a dedicated compression codec for picture of the UI are actively in progress.

Specifically, an image codec for UI picture requires a fast decoding speed. Most pictures of the UI have to be display immediately when the user presses buttons. Therefore, in decoding an image stored for UI, a delay time that the user feels has to be minimized. The image has to be decoded and displayed fast as the user cannot feel the delay time. In most cases, the decoding and display have to be completed within 100 ms. For most of the mobile phones, for example a portable phone, a low-performance central processing unit (CPU) such as an advanced RISC machine 7 (ARM7) and ARM9 controls the UI and thus it is difficult to use a codec such as JPEG having a large amount of computation.

A UI picture dedicated codec is characterized in that artificially created simple pictures can be compressed to a certain degree but general photographs such as nature pictures cannot be readily compressed even by half of their original size. Although most UI pictures were artificially created and simple, nature pictures are now increasingly used for the UI. For example, photographs are widely used for a screen background.

Use of free processing technology in consideration of these facts can result in large compression ratio of the UI screen dedicated codec.

Among the image codec and free processing technologies, a color space conversion is one of the most popular technologies. In such a technology, color conversion is performed using Y, Cb, and Cr components to reduce overlapping between R, G, and B color components. Next, since human eyes are more sensitive to brightness than colors, Cb and Cr values are sub-sampled as input values for a final compression block.

This sub-sampling method is used for a still picture standard codec JPEG and moving picture standard codecs H.263, MPEG4, and H.264 in the form of a 4:2:0 sub-sampling configuration. The 4:2:9 sub-sampling means that, if there are four pixels, the Y component representing brightness is expressed using all the four pixel values, and the Cb and Cr color components are expressed using only one of the four pixels. This is based on the fact that human eyes are more sensitive to brightness than colors. In this way, picture data can be reduced by half by the 4:2:0 conversion of the Y, Cb, and Cr components.

Matrixes for conversion between R, G, and B components and Y, Cb, and Cr components is expressed in Equations 1 and 2 below.
Y=0.29900×R+0.58700×G+0.11400×B
Cb=−0.16874×R−0.33126×G+0.50000×B
Cr=0.50000×R−0.41869×G−0.08131×B (Eq. 1)
R=Y+1.40200×Cr
G=Y−0.34414×Cb−0.71414×Cr
B=Y+1.77200×Cb (Eq. 2)

Y, Cb, and Cr color components can be obtained from R, G, and B components by using Equation 1, and R, G, B components can be reversely obtained from Y, Cb, and Cr components by using Equation 2.

However, since those conversion matrixes include floating-point calculation, it cannot be directly used for an ARM processor having a relative low performance because of the calculation load. To solve this problem, the 3×3 color conversion matrix is modified for integer calculation. In detail, each component of the matrix is multiplied by 2¹⁶ when converting R, G, and B into Y, Cb, and Cr, and each component of the matrix is divided by 2¹⁶ when converting Y, Cb, and Cr into R, G, and B. In this way, floating-point calculation can be avoided. In addition to this technique, each component of the matrix is previously multiplied by RGB component value range of 0 to 255 to obtain a table. This table is used for JPEG conversion in order to avoid multiplication calculation. In this case, although the multiplication calculation can be avoided, an additional memory space is required for storing the table. For RGB-to-YCbCr conversion, eight tables each having 256 entries are required. On the contrary, four tables each having 256 entries are required for YCbCr-to-RGB conversion. Since the multiplication calculation can be avoided, actual color conversion speed can be significantly improved.

However, when this table is used, the ARM processor must continuously access the memory storing a table. Since many clocks are consumed during the memory access time, it is burdensome to apply the abovementioned method to a mobile terminal. Therefore, there is required a technique capable of solving the above problem by preprocessing the picture codec using a dictionary-based codec scheme.

### SUMMARY OF THE INVENTION

Accordingly, the present invention is directed to a method of coding and decoding a still picture that substantially obviate one or more problems due to limitations and disadvantages of the related art.

An object of the present invention is to provide a method of coding/decoding a still picture based on a preprocessing technique for coding/decoding a still picture requiring a high decoding speed and a higher coding rate.

Another object of the present invention is to provide a method of coding/decoding a still picture using an integer-integer color transform, in which the integer-integer color transform is performed, a quantization process is performed, and the coding/decoding operation can be performed using the resulting data as the input of a dictionary-based codec.

A further another object of the present invention is to provide a method of coding/decoding a still picture by a color space transform scheme for a high processing speed, when a picture is coded using a dictionary-based coding scheme that is used to express all color values in a 8-bit value without the loss of the picture quality using the characteristics of the YUV color space.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of coding a still picture, including: transforming color components of image data based on a first color space into components on a first color space using an integer-integer color transform; and constructing frames for the transformed components on the second color space and coding image data of the frames by a dictionary-based coding scheme.

In another aspect of the present invention, there is provided a method of coding a still picture, including: transforming color components of image data based on an RGB color space into components on a YUV color space using an integer-integer color transform; reconstructing U/V color values of the Y/U/V color components in a defined number of bits; constructing frames for the Y component and the reconstructed U/V components; and coding the Y/U/V values of the frames by a dictionary-based coding scheme.

In a further another aspect of the present invention, there is provided a method of decoding a still picture of coded image data that are transformed from a first color space to a second color space using an integer-integer color transform, the method including: inversely transforming the coded image data based on the second color space into the first color space; and decoding the inversely-transformed image data using a dictionary-based transform.

In a further another aspect of the present invention, there is provided a method of coding a still picture, including: transforming 8-bit color components of image data on an RGB color space into image data on a YUV color space by {Y=[(R+2G+B)/4], U=[R−G], V=[B−G]}; reconstructing each of U/V color values of the Y/U/V color components in an 8-bit value by [(U,V)/2+128]; constructing frames for the transformed Y component and the reconstructed U/V components; and coding the Y/U/V values of the frames by a dictionary-based coding scheme.

The first color space may be an RGB color space.

The second color space may be a YUV color space.

The color transform operation may include reconstructing the color values of the components in a defined number of bits.

According to the present invention, the UI picture can be rapidly coded and displayed in a mobile terminal. Also, the memory of the system can be saved. The present invention can efficiently code not only an artificial simple picture but also a natural picture, and thus can be efficiently applied to the construction of the UI using the natural picture. The color transform method according to the present invention can be used as the preprocessing of the UI-dedicated codec requiring a rapid coding time and a high coding rate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram illustrating a color transform according to the present invention; and

FIG. 2 is a flowchart illustrating a method of coding a still picture using the color transform according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In a color space, a Y component represents brightness and U/V components represent color. In general, a brightness component (Y) is sensitive to a picture quality. Therefore, a coding algorithm is implemented such that a loss occurs on the color components U/V insensitive to the picture quality, rather than the brightness component Y sensitive to the picture quality. In the present embodiment, in consideration of the above characteristics, the Y component is transformed into 8-bit value by an integer transform operation, and the U/V components are transformed into 9-bit values and reconstructed in 8-bit value.

Examples of the color transform are an irrevisible color transform (ICT) and a revisible color transform (RCT) using an integer-integer color transform. The present invention uses the integer-integer color transform. Equations 3 and 4 below express transformation between R/G/B color components and Y/U/V color components.
Y=[R+2G+B/4]
U=R−G
V=B−G (Eq. 3)
G=Y−[U+V/4]
R=U+G
B=V+G (Eq. 4)

Here, a function [w] means the largest integer among integers equal to or smaller than ‘w’. Equation 3 expresses a method of transforming color components on an RGB color space into color components on a YUV color space. Equation 4 expresses a method of transforming color components on a YUV color space into color components on an RGB color space.

As can be seen from Equations 3 and 4, the integer-integer color transform is advantageous because it does not require a multiplication operation. Therefore, the integer-integer color transform can be efficiently used for a UI-dedicated codec requiring a high-speed decoding and a good compression rate.

In the integer-integer color transform using Equations 3 and 4, the Y component can be expressed in an 8-bit value, while the U/V components are expressed in a 9-bit value. However, a dictionary-based coding scheme uses an 8-bit pixel value as a basic unit. Also, when the above pixel values are expanded into 16-bit values so as to process the 9-bit color values obtained by the above transform using the dictionary-based coding scheme is used to process, an amount of data undesirably increases. Accordingly, the 9-bit UV color value is beforehand reconstructed in an 8-bit pixel value prior to coding it by the dictionary-based coding scheme.

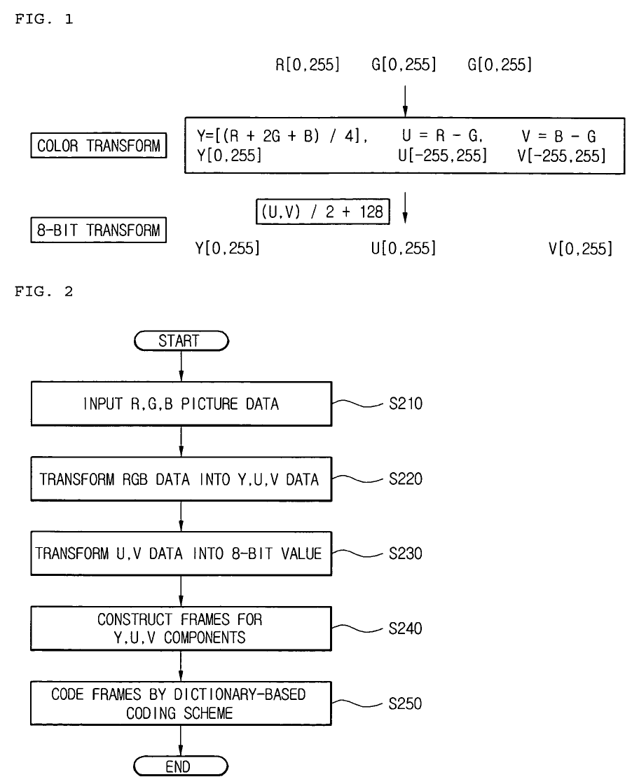

FIG. 1 is a conceptual diagram illustrating a color transform according to the present invention.

Referring to FIG. 1, in the present color transform method, R/G/B color components expressed in the RGB color space are transformed into Y/U/V components by the integer-integer color transform equation.

For 8-bit color components R[0,255], G[0,255] and B[0,255], Y/U/V components are obtained by Equation 5 below.
Y=[(R+2G+B)/4], U=[R−G], V=[B−G] (Eq. 5)

The transform results in the range of Y[0,255], U[−255,255] and V[−255,255]. That is, the Y component is expressed in an 8-bit value, and the U/V components are expressed in a 9-bit value. For the dictionary-based coding operation, the 9-bit U/v components are reconstructed into 8-bit values.

To this end, the U/V components with a 9-bit pixel length are quantized by dividing each of them by 2. 128 is added to the resulting values to convert the 9-bit U/V component values into 8-bit U/V component values in the range of 0˜255. That is, the 9-bit U/V values are expressed in an 8-bit value by a formula of [(U,V)/2+128]. The color transform results in the range of Y[0,255], U[0,255] and V[0,255]

FIG. 2 is a flowchart illustrating a method of coding a still picture using the color transform according to an embodiment of the present invention.

Referring to FIG. 2, picture data expressed in the RGB color space are inputted in operation S210. The inputted picture data may be a 24-bit format including 8-bit R/G/B component values, an 18-bit format including 6-bit R/G/B components, or a 16-bit format including a 6-bit G component value and 5-bit R/B component values. In operation S220, the inputted picture data are transformed into Y/U/V components by the integer-integer color transform equation described above. Consequently, the inputted picture data are transformed into Y/U/V components including an 8-bit Y component and 9-bit U/V components.

Thereafter, for the dictionary-based coding, the 9-bit U/v components are reconstructed into an 8-bit format by the formula of [(U,V)/2+128] in operation S230. That is, for the above reconstruction, the U/V component values are each divided by 2 and 128 is added to each of the resulting values, resulting in U/V component values expressed in the range of 0˜255. Since 256=2⁸, the U/V component values expressed in the range of 0˜255 can be expressed in 8-bit data.

In operation S240, three frames are constructed for the 8-bit Y component value resulting from operation S220 and the 8-bit U/V component values. In operation S250, the dictionary-based coding operation is performed on the three frames.

The image data coded by the present coding method are decoded as follows. As described above, the coding operation is performed using the color space transform expressed in Equation 3. The decoding operation is performed using the color space transform expressed in Equation 4, thereby transforming image data on the YUV color space into image data on the RGB color space. That is, the image data on the YUV color space are transformed into the image data on the RGB color space by the operation of G=Y−[U+V/4], R=U+G, B=V+G. The dictionary-based decoding algorithm is performed on the transformed RGB color values, thereby restoring the original still picture data.

The dictionary-based coding/decoding scheme is a scheme that encodes/decodes a current portion with reference to the previously-encoded portion. That is, a current portion is encoded with reference to N number of data spaced apart from the current encoding point by a distance D. When the matched number N of the current portion and the previously-encoded portion is below a predetermined value, the current pixel value is encoded without reference to the previously-encoded portion. On the other hand, when the matched number of the current portion and the previously-encoded portion exceeds the predetermined value, the coding operation is performed from the current encoding point by encoding the distance D and the matched number N. The dictionary-based decoding scheme can be similarly performed.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A method for coding a still picture, comprising:
transforming color components of image data based on a first color space into components on a first color space using an integer-integer color transform; and
constructing frames for the transformed components on the second color space and coding image data of the frames by a dictionary-based coding scheme.

2. The method according to claim 1, wherein the first color space is an RGB color space.

3. The method according to claim 1, wherein the second color space is a YUV color space.

4. The method according to claim 1, wherein the color transform operation includes reconstructing the color values of the components in a defined number of bits.

5. The method according to claim 1, wherein the first color space and the second color space are respectively an RGB color space and a YUV color space, and an RGB/YUV transform is performed by {Y=[(R+2G+B)/4], U=[R−G], V=[B−G]}.

6. The method according to claim 1, wherein the first color space and the second color space are respectively an RGB color space and a YUV color space, an RGB/YUV transform is performed by {Y=[(R+2G+B)/4], U=[R−G], V=[B−G]}, and the Y/U/V color components are reconstructed in the defined number of bits by [(U,V)/2+128].

7. The method according to claim 1, wherein the image data based on the first color space are expressed in a 24-bit color value on an 8-bit RGB color space.

8. The method according to claim 1, wherein the image data based on the first color space are expressed in an 18-bit color value on a 6-bit RGB color space.

9. The method according to claim 1, wherein the image data based on the first color space are expressed in a 16-bit color value on a 5-bit R, 6-bit G and 5-bit B color space.

10. A method for coding a still picture, comprising:
transforming color components of image data based on an RGB color space into components on a YUV color space using an integer-integer color transform;
reconstructing U/V color values of the Y/U/V color components in a defined number of bits;
constructing frames for the Y component and the reconstructed U/V components; and
coding the Y/U/V values of the frames by a dictionary-based coding scheme.

11. The method according to claim 10, wherein the RGB/YUV transform is performed by {Y=[(R+2G+B)/4], U=[R−G], V=[B−G]}.

12. The method according to claim 10, wherein the RGB/YUV transform is performed by {Y=[(R+2G+B)/4], U=[R−G], V=[B−G]}, and the Y/U/V color components are reconstructed in the defined number of bits by [(U,V)/2+128].

13. A method for decoding a still picture of coded image data that are transformed from a first color space to a second color space using an integer-integer color transform, the method comprising:
inversely transforming the coded image data based on the second color space into the first color space; and
decoding the inversely-transformed image data using a dictionary-based transform.

14. The method according to claim 13, wherein the first color space is an RGB color space.

15. The method according to claim 13, wherein the second color space is a YUV color space.

16. The method according to claim 13, wherein the first color space and the second color space are respectively an RGB color space and a YUV color space, and image data expressed in the YUV color space are transformed into the RGB color space by {G=Y−[U+V/4], R=U+G, B=V+G}, with respect to image data color-transformed and coded by {Y=[(R+2G+B)/4], U=[R−G], V=[B−G]}.

17. A method for coding a still picture, comprising:
transforming 8-bit color components of image data on an RGB color space into image data on a YUV color space by {Y=[(R+2G+B)/4], U=[R−G], V=[B−G]};
reconstructing each of U/V color values of the Y/U/V color components in an 8-bit value by [(U,V)/2+128];
constructing frames for the transformed Y component and the reconstructed U/V components; and
coding the Y/U/V values of the frames by a dictionary-based coding scheme.
